(19) United States
(12) Patent Application Publication
(10) Pub. No.: US 2010/0109348 A1
(43) Pub. Date: May 6, 2010

(54) Locking Pin

(76) Inventor: Zine Eddine Boutaghou, North Oaks, MN (US)

Correspondence Address: Karl G Schwappach, 17 south Long Lake Trail, North Oaks, MN, 55127, US

(21) Appl. No.: 12/684,909

(22) Filed: Jan. 9, 2010

Related U.S. Application Data
(62) Division of application No. 11/971,571, filed on Jan. 9, 2008, now abandoned.

(51) Int. Cl. E05C 1/04

(52) U.S. Cl. 292/152

(57) ABSTRACT

A retractable locking pin. The locking pin includes a catch, a biasing means, a stop, a strut and an activation member. The catch is radially respositionable relative to the longitudinal axis of the locking pin as between an outward expanded position and an inward contracted position. The biasing means biases the catch towards the outward expanded position. The stop is longitudinally spaced from the catch and extends radially outward from the longitudinal axis. The strut cooperatively interconnects the biasing means and the stop. The activation member is operably associated with at least one of the catch and the biasing means for repositioning the catch towards the inward contracted position against the bias of the biasing means when the activation member is repositioned in a first direction along a path relative to the stop.

The present application is a Divisional of U.S. patent application Ser. No. 11/971,571 entitled Locking Pin, filed Jan. 9, 2008, the entire disclosure of which is incorporated herein.

### BACKGROUND OF THE INVENTION

A wide array of locking pins or fasteners are known, such as disclosed in U.S. Pat. No. 4,318,650 (LLauge); U.S. Pat. No. 5,366,332 (Murphy); and U.S. Patent Publication No. 2006/0231690 (Cooley et al.). However, a continuing need exists for low cost locking pins capable of quickly, easily, reliably and securely connecting elements while permitting quick, easy and nondestructive disconnection of connected elements.

### SUMMARY OF THE INVENTION

The invention is a locking pin. The locking pin includes a catch, a biasing means, a stop, a strut and an activation member. The catch is radially respositionable relative to the longitudinal axis of the locking pin as between an outward expanded position and an inward contracted position. The biasing means biases the catch towards the outward expanded position. The stop is longitudinally spaced from the catch and extends radially outward from the longitudinal axis. The strut cooperatively interconnects the biasing means and the stop. The activation member is operably associated with at least one of the catch and the biasing means for repositioning the catch towards the inward contracted position against the bias of the biasing means when the activation member is repositioned in a first direction along a path relative to the stop.

### BRIEF DESCRIPTION OF THE DRAWINGS

FIG. 1 is a cross-sectional perspective view of one embodiment of the invention.

FIG. 2 is a front view of another embodiment of the invention.

FIG. 3 is a front view of another embodiment of the invention locking together overlapping elements.

FIG. 4 is a front view of another embodiment of the invention with parts separated to facilitate viewing of otherwise obstructed components.

FIG. 5 is a front view of another embodiment of the invention.

FIG. 6 is a cross-sectional view of the invention shown in FIG. 5.

FIG. 7 is an enlarged view of the bottom portion of the invention shown in FIG. 5.

FIG. 8 is a front view of another embodiment of the invention.

FIG. 9 is a perspective view of the insert unit portion of the invention shown in FIG. 8.

### DETAILED DESCRIPTION OF THE INVENTION

For ease of reference, the various components and features of the claimed invention will be generically identified by a common base reference number (i.e., strut 30), with a superscript designation provided when that component or feature on a specific embodiment is being referenced (i.e., locking pin 30³ for the strut on the third embodiment).

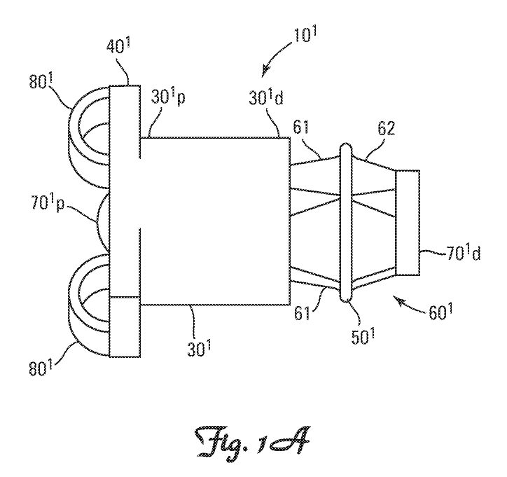

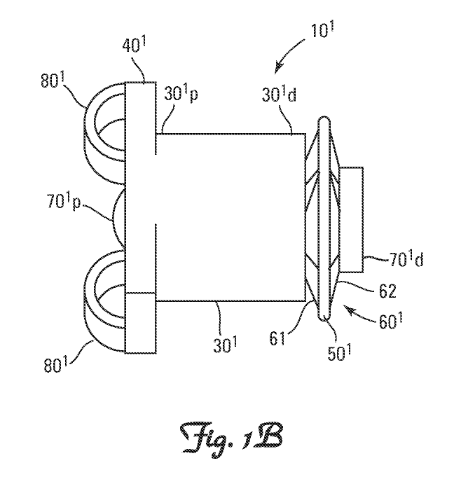

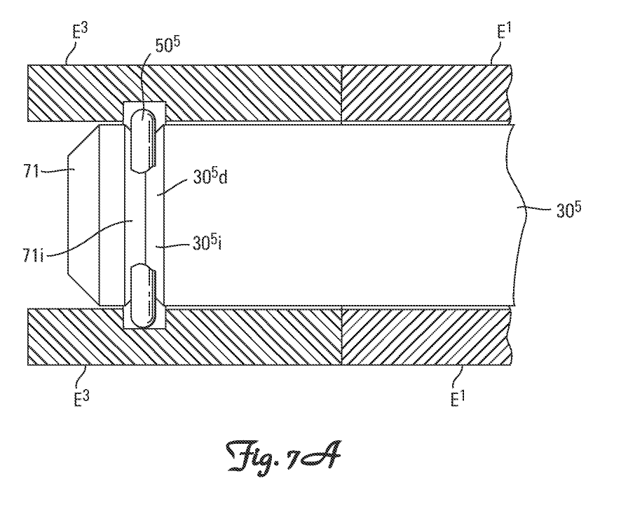

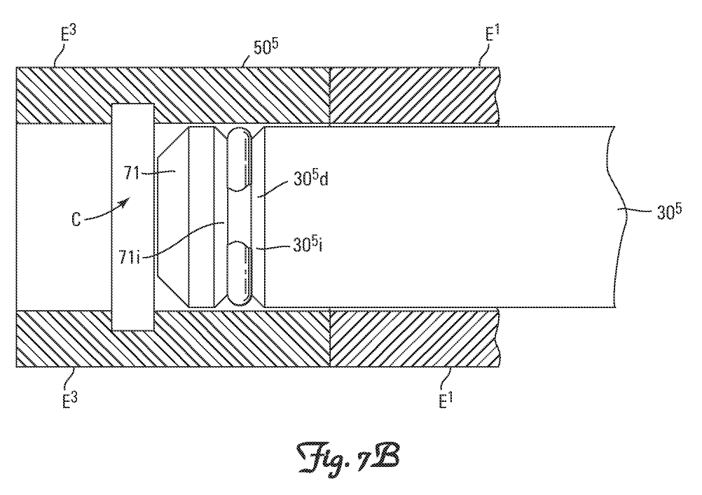

Referring generically to FIGS. 1-9, the invention is a locking pin 10. The locking pin 10 includes a strut 30, a stop 40, a catch 50, a biasing means 60 and an activation member 70. The locking pin 10 is configured and arranged for releasably connecting an overlapping set of an uppermost element E₁ a lowermost element E₃ and any number of intermediate elements E₂ by inserting the locking pin 10 into aligned holes H₁, H₂ and H₃ in the elements E₁, E₂ and E₃ respectively, until the stop 40 engages the exposed major surface (unnumbered) of the uppermost element E₁ and the catch 50 is biased into a circumferential channel C provided within the hole H₃ in the lowermost element E₃. For purposes of clarity only, the balance of the disclosure shall be based upon use of the locking pin 10 to interconnect only an uppermost element E₁ and a lowermost element E₃.

The strut 30 is configured and arranged to provide the necessary structural framework for supporting and interconnecting the other components of the interlocking pin 10. The strut 30 has a proximal end 30p and a distal end 30d, cooperatively interconnects the stop 40 and the biasing means 60 on the locking ping 10, and is configured and arranged for insertion into holes H₁ and H₃ provided in an uppermost element E₁ and a lowermost element E₃ to be connected by the locking pin 10.

The stop 40 extends radially R outward from the longitudinal axis x of the locking pin 10 for engaging the exposed major surface (unnumbered) of an uppermost element E₁ when the locking pin 10 is fully inserted into aligned holes H₁ and H₃ in an uppermost element E₁ and a lowermost element E₃ with the catch 50 biased into the circumferential channel C in the lowermost element E₃. By contacting the exposed major surface (unnumbered) of an uppermost element E₁ the stop 40 prevents continued movement of the locking pin 10 into the holes H₁ and H₃.

The catch 50 is configured and arranged for locking insertion into and selective retraction from a circumferential channel C provided within a hole H₃ in a lowermost element E₃ to be connected by the locking pin 10. The catch 50 is longitudinally spaced from the stop 40 and is radially R respositionable relative to the longitudinal axis x of the locking pin 10 as between an outward expanded or locking position and an inward contracted or retraction position.

The biasing means 60 is constructed, configured and arranged to bias the catch 50 towards the outward expanded position. Substantially any of the well know devices and techniques for providing such a bias may be usefully employed in this invention, including specifically, but not exclusively rubber bands, springs, rubber gaskets, pressurized air chambers, etc.

The activation member 70 is constructed, configured and arranged to selectively reposition the catch 50 from an outward expanded or locking position into an inward contracted or retraction position against the bias of the biasing means 60. The activation member 70 has a proximal end 70p and a distal end 70d, and is operably associated with at least one of the catch 50 and the biasing means 60 for repositioning the catch 50 towards the inward contracted position when the activation member 70 is repositioned in a first direction along a path relative to the stop 40.

The invention encompasses a wide range of embodiments. Without intending to be limited thereby, several specific embodiments of the invention are described in detail below.

### First Embodiment

A first embodiment of the locking pin 10¹ is shown in FIG. 1. The first embodiment of the locking pin 10¹ includes a strut 30¹, a stop 40¹, a catch 50¹, a biasing means 60¹ and an activation member 70¹ constructed as a single unitary continuous elastic piece.

The strut 30¹ is a hollow cylinder defining a longitudinally x extending central bore 39¹.

The stop 40¹ is an annular flange extending radially R outward from the proximal end 30¹p of the strut 30¹.

The biasing means 60¹ is an elastic bellows 60¹ with a forward disc 61 and a rearward disc 62 defining an apex 60¹_{A}. The inner periphery (unnumbered) of the forward disc 61 cooperatively engages the strut 30¹ while the inner periphery (unnumbered) of the rearward disc 62 cooperatively engages the activation member 70¹.

The catch 50¹ is a ring attached to the bellows 60¹ at the apex 60¹_{A}.

The activation member 70¹ is slidably engaged within the bore 39¹ defined by the strut 30¹, with the proximal end 70¹p of the activation member 70¹ projecting in a first longtitudinal direction x₁ out from the proximal end 30¹p of the strut 30¹, and the distal end 70¹d of the activation member 70¹ cooperatively engaging the rearward disc 62 of the bellows 60¹.

Movement of the activation member 70¹ in the second longitudinal direction x₂ relative to the strut 50¹ effects a longitudinal x separation of the inner periphery of the forward disc 61 and the inner periphery of the rearward disc 62 against the bias of the bellows 60¹, thereby effecting a radial R repositioning of the catch 50¹ relative to the longitudinal axis x of the locking pin 10¹ from an outward expanded position towards an inward contracted position. Release of the activation member 70¹ allows the bellows 60¹ to return to its biased position, thereby returning the catch 50¹ to the outward expanded position.

A pair of longitudinally x projecting finger tabs 80¹ can be provided on the stop 40¹ for facilitating retraction of the locking pin 10¹. The finger tabs 80¹ depicted in FIG. 1 are radially spaced from and diametrically positioned about the longitudinal axis x. The finger tabs 80¹ project longitudinally x from the stop 40¹ in a first longitudinal direction x₁ away from the catch 50¹. The finger tabs 80¹ are configured and arranged for engaging the tips of a pointer finger (not shown) and a middle finger (not shown). The finger tabs 80¹ facilitating retraction of a locking pin 10¹ by allowing a user to pull the finger tabs 80¹ in the first longitudinal direction x₁ with a pointer (not shown) and middle (not shown) fingers while pushing the activation member 70¹ with the thumb (not shown) on the same hand (not shown) in a second longitudinal direction x₂ opposite the first longitudinal direction x₁ to reposition the catch 50¹ into the inward retraction position, thereby permitting the locking pin 10¹ to be pulled out from the holes H₁ and H₃ in the connected elements E₁ and E₃ respectively.

### Second Embodiment

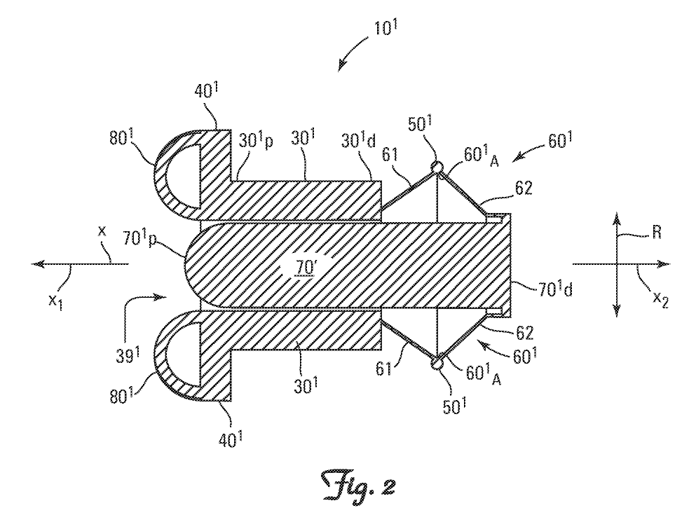

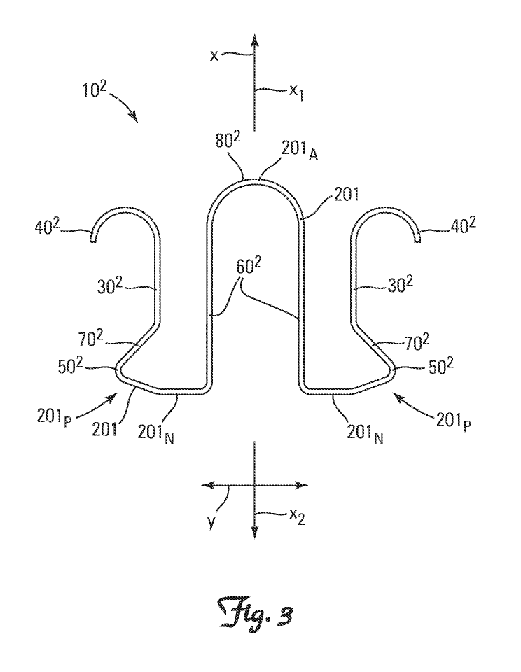

A second embodiment of the locking pin 10² is shown in FIG. 2. The second embodiment of the locking pin 10² is formed from a single, unitary, continuous strand 201 of elastic material, such as an elongated cylindrical filament, with a generally sinusoidal shape. Various lengths along the shaped strand 201 function as a strut 30², a stop 40², a catch 50², a biasing means 60² and an activation member 70². The generally sinusoidal shape of the strand 201 defines a central apex 201_{A}, and radially spaced left and right nadirs 201_{N}.

The strand 201 defines a strut 30² on each side extending from the length functioning as the stop 40² to the length functioning as the activation member 70².

Laterally extending arched wings 40² extending from each strut 30² function as a stop 40².

The catch 50² is formed by outwardly extending protrusions 201_{P} provided proximate each nadir 201_{N} on the strand 201.

The longitudinally extending lengths of the strand 201 on either side of the central apex 201_{A} function as the biasing means 60² for laterally y biasing the catch 50² away from the central longtiduinal axis x of the locking pin 10².

The length of the strand 201 extending inward from each catch 50² towards the longitudinal axis x of the locking pin 10² at an acute angle, preferably an angle of about 20° to 60°, relative to the longitudinal axis x functions—in cooperation with the finger tab 80² formed at the apex 201_{A} of the strand 201—as the activation member 70².

The locking pin 10² can be pulled out from the holes H₁ and H₃ in connected elements E₁ and E₃ by simply gripping the locking pin 10² at the apex 201_{A} and pulling “up” in the first longitudinal direction x₁ away from the elements E₁ and E₃. Pulling “up” on the locking pin 10², causes the angled activation members 70² on each side of the strand 201 to slide against the upper corner (unnumbered) of the channel C in the lowermost element E₃, thereby causing the catch 50² to move inward towards the longitudinal axis x of the locking pin 10², from an outward expanded position towards an inward contracted position, until the catch 50² is completely removed from the channel C.

### Third Embodiment

A third embodiment of the locking pin 10³ is shown in FIG. 3. The third embodiment of the locking pin 10³ is nearly identical to the second embodiment of the locking pin 10² except that the longitudinally x extending lengths of the strand 301 extending from the central apex 301_{A} to the nadirs 301_{N} on each side are rigidly attached to one another so as to prevent radial R repositioning of these lengths relative to one another, thereby shifting the length of the strand 301 functioning as the biasing means 60³ from these longitudinally x extending lengths of the strand 301 to the laterally y extending lengths of the strand 301 at the nadirs 301_{N}.

### Fourth Embodiment

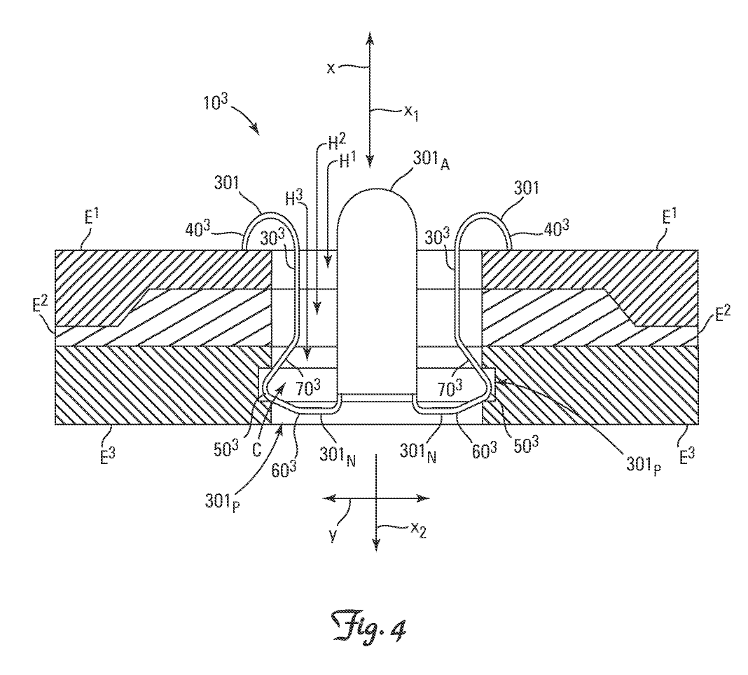

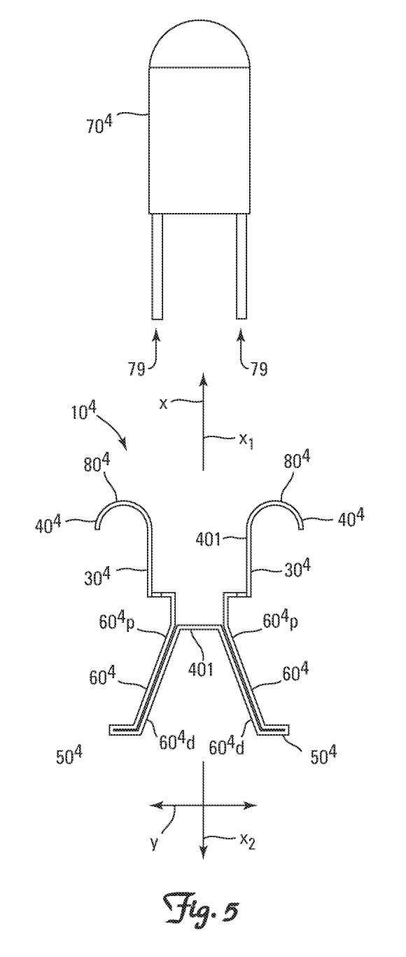

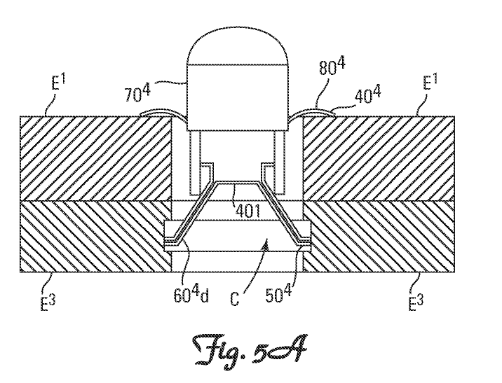

A fourth embodiment of the locking pin 10⁴ is shown in FIG. 4. The fourth embodiment of the locking pin 10⁴ employs a single, unitary, continuous strand 401 of elastic material, such as an elongated cylindrical filament, to form the strut 30⁴, stop 40⁴, catch 50⁴ and biasing means 60⁴, in this embodiment a pair of leaf springs 60⁴. The activation member 70⁴ in the fourth embodiment is a separate component configured and arranged to interact with the strand 401.

The strand 401 defines a strut 30⁴ on each side extending from the length functioning as the stop 40⁴ to the length functioning as the biasing means 60⁴.

Laterally y extending arched wings 40⁴ extending from each strut 30⁴ function as stops 40⁴.

The catch 50⁴ is formed by legs 50⁴ extending laterally y outward from the distal end 60⁴d of each leaf spring 60⁴.

The lengths of the strand 401 extending in the second longitudinal direction x₂ from each strut 30⁴ form leaf springs 60⁴. The leaf springs 60⁴ extend from the struts 30⁴ at an acute angle, preferably at a 10° to 60° angle, relative to the longitudinal axis x of the locking pin 10⁴. The leaf springs 60⁴ may be linear or curved, so long as they can be operably engaged by the activating member 70⁴ for inward movement against the bias exerted by the leaf springs 60⁴ towards the longitudinal axis x of the locking pin 10⁴.

The activation member 70⁴ is a rigid member with longitudinal x channels 79 for slidably engaging the strut 30⁴ and the leaf springs 60⁴, When slid along the length of the leaf springs 60⁴ in the second longitudinal direction x₂ the activation member 70⁴ progressively squeezes the leaf springs 60⁴ laterally y inward towards one another against the outward bias exerted by the leaf springs 60⁴.

The locking pin 10⁴ can be retracted from the holes H₁ and H₃ in connected elements E₁ and E₃ in a fashion similar to the technique used to retract the first embodiment of the locking pin 10¹. A user simply pulls “up” on the finger tabs 80⁴ formed by each stop 40⁴ in the first longitudinal direction x₁ with the pointer (not shown) and middle (not shown) fingers while pushing the activation member 70⁴ “downward” with the thumb (not shown) on the same hand (not shown) in a second longitudinal direction x₂ opposite the first longitudinal direction x₁ to reposition the catches 50⁴ into an inward retraction position, thereby permitting the locking pin 10⁴ to be pulled out from the holes H₁ and H₃ in the connected elements E₁ and E₃ respectively.

### Fifth Embodiment

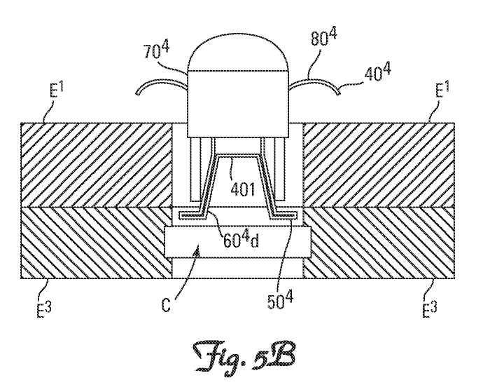

A fifth embodiment of the locking pin 10⁵ is shown in FIGS. 5, 6 and 7. The fifth embodiment of the locking pin 10⁵ includes a strut 30⁵, a stop 40⁵, a catch 50⁵, a biasing means 60⁵ and an activation member 70⁵.

The strut 30⁵ is a hollow cylinder defining a longitudinally x extending central bore 39⁵. The distal end 30⁵d of the strut 30⁵ is beveled to provide an inclined surface.

The stop 40⁵ is an annular flange extending radially R outward from the proximal end 30⁵p of the strut 30⁵.

The activation member 70⁵ is slidably engaged within the bore 39⁵ defined by the strut 30⁵. The activation member 70⁵ includes a base 71 configured and arranged to engage the distal end 30⁵d of the sleeve 30⁵, and a finger 72 longitudinally x extending from the base 71 through the bore 39⁵ in the sleeve 30⁵ with a proximal end 72p of the finger 72 projecting longitudinally x beyond the proximal end 30⁵p of the sleeve 30⁵. The “forward” facing outer edge 71i on the base 71 is beveled.

The biasing means 60⁵ is a spring 60⁵ positioned within the bore 39⁵ defined by the sleeve 30⁵ and restrained between a shoulder (unnumbered) projecting into the bore 39⁵ from the sleeve 30⁵ and a shoulder (unnumbered) on the finger 71 of activating member 70⁵ for biasing the activating member 70⁵ in a first longitudinal direction x₁ away from the catch 50⁵.

The catch 50⁵ is a radially expandable elastic O-ring or retaining ring positioned intermediate the distal end 30⁵d of the sleeve 30⁵ and the base 71 of the activation member 70⁵. When the activating member 70⁵ is in its biased position abutting the base 71 of the activation member 70⁵, the facing beveled edges 30⁵i and 71i on the strut 30⁵ and the base 71 of the actuation member 70⁵ respectively, force the catch 50⁵ to expand outward by moving the catch 50⁵ “up” one or both of the beveled edges 30⁵i and 71i.

Movement of the activation member 70⁵ in the second longitudinal direction x₂ relative to the strut 50⁵ effects a longitudinal x separation of the facing beveled edges 30⁵i and 71i on the strut 30⁵ and the base 71 of the actuation member 70⁵ against the bias of the spring 60⁵, thereby allowing the catch 50⁵ to move “down” the beveled edges 30⁵i and 71i so as to effect a radial R repositioning of the catch 50⁵ relative to the longitudinal axis x of the locking pin 10⁵ from an outward expanded position to an inward contracted position. Release of the activation member 70⁵ allows the spring 60⁵ to force the beveled edges 30⁵i and 71i back towards one another, thereby returning the catch 50⁵ to the outward expanded position.

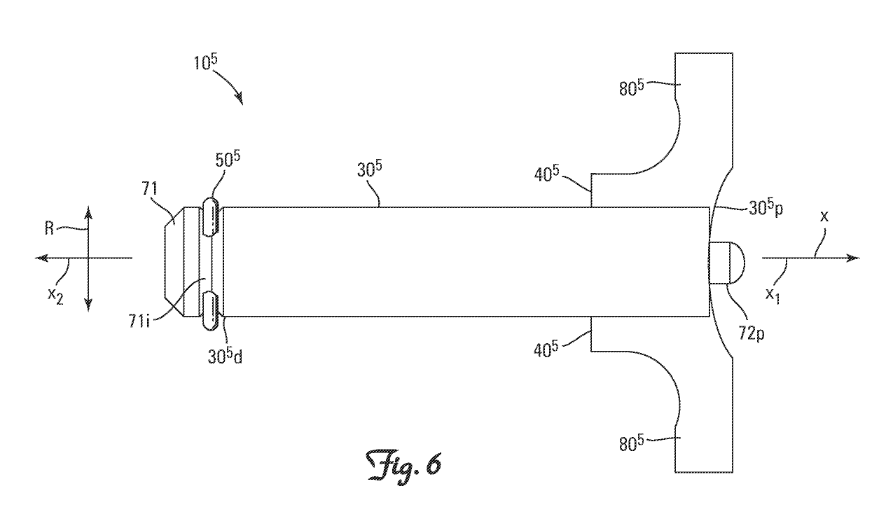

A pair of longitudinally x projecting finger tabs 80⁵ can be provided on the stop 40⁵ for facilitating retraction of the locking pin 10⁵. The finger tabs 80⁵ depicted in FIGS. 5 and 6 are radially R spaced from and diametrically positioned about the longitudinal axis x. The finger tabs 80⁵ project longitudinally x from the stop 40⁵ in a first longitudinal direction x₁ away from the catch 50⁵. The finger tabs 80⁵ are configured and arranged for engaging the tips of a pointer finger (not shown) and a middle finger (not shown). The finger tabs 80⁵ facilitate retraction of a locking pin 10⁵ by allowing a user to pull the finger tabs 80⁵ in the first longitudinal direction x₁ with a pointer (not shown) and middle (not shown) fingers while pushing the distal end 72⁵d of the finger 72 on the activation member 70⁵ with the thumb (not shown) on the same hand (not shown) in a second longitudinal direction x₂ opposite the first longitudinal direction x₁ to allow the catch 50⁵ to repositioned itself into the inward retraction position, thereby permitting the locking pin 10⁵ to be pulled out from the holes H₁ and H₃ in the connected elements E₁ and E₃ respectively.

### Sixth Embodiment

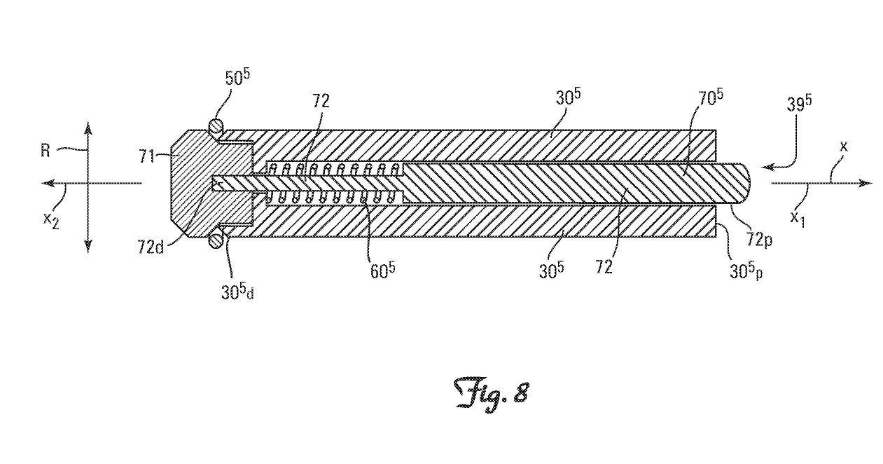

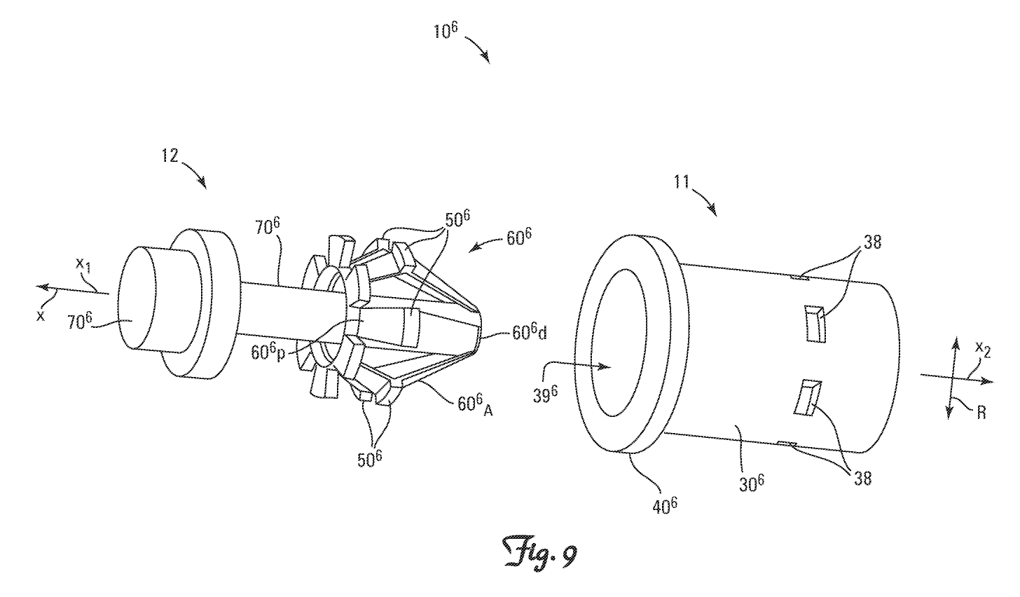

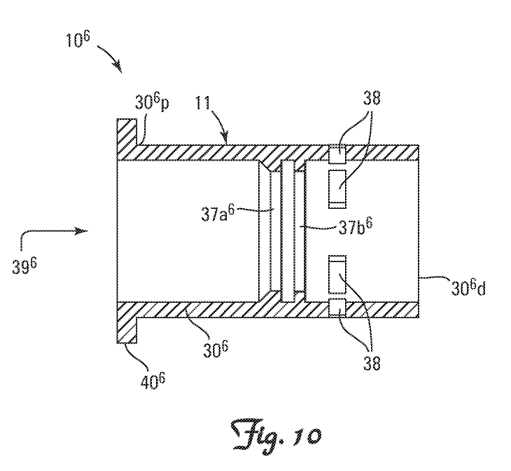

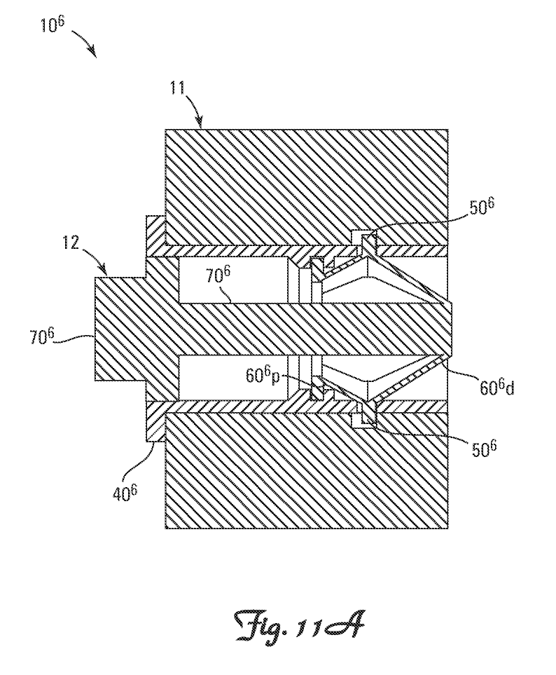

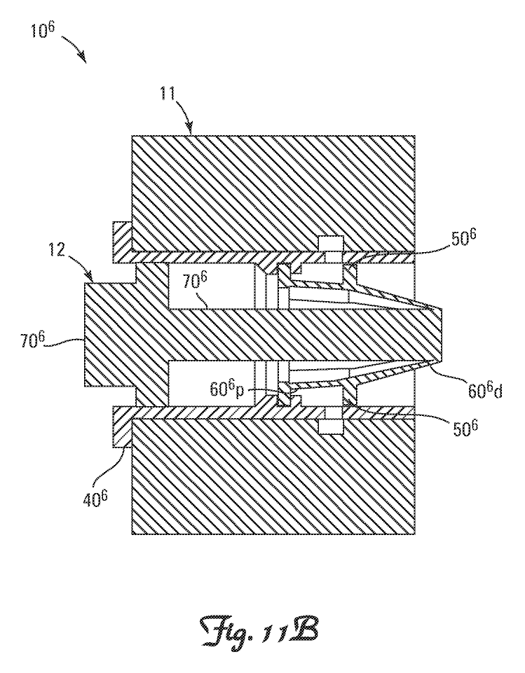

A sixth embodiment of the locking pin 10⁶ is shown in FIGS. 8 and 9. The sixth embodiment of the locking pin 10⁶ includes separate and independent housing 11 and insert 12 units. The housing unit 11 embodies the strut 30⁶ and stop 40⁶, while the insert unit 12 embodies the catch 50⁶, biasing means 60⁶ and activation member 70⁶.

The strut 30⁶ is a hollow cylinder defining a longitudinally x extending central bore 39⁶. A plurality of circumferentially spaced openings 38 are provided through the sidewall (unnumbered) of the strut 30⁶ proximate the distal end 30⁶d of the strut 30⁶ for accommodating passage of the catches 50⁶ on the insert unit 12.

The stop 40⁶ is an annular flange extending radially R outward from the proximal end 30⁶p of the strut 30⁶.

The biasing means 60⁶ is a plurality of circumferentially spaced outwardly biased concave leaf springs 60⁶. Each leaf spring 60⁶ has longitudinally spaced proximal 60⁶p and distal 60⁶d ends and a radial apex 60⁶_{A} intermediate the ends 60⁶p and 60⁶d. The proximal ends 60⁶p of the leaf springs 60⁶ are interconnected for cooperatively engaging an inner shoulder (not shown) within the bore 39⁶ of the strut 30⁶. The distal ends 60⁶d of the leaf springs 60⁶ cooperatively engage the activation member 70⁶.

The catches 50⁶ are projections extending radially R from the apex 60⁶_{A} of each leaf spring 60⁶. The catches 50⁶ are sized, shaped, configured and arranged for passage through the openings 38 in the strut 30⁶ and into locking insertion into and selective retraction from a circumferential channel C provided within a hole H₃ in a lowermost element E₃ to be connected by the locking pin 10⁶. The catches 50⁶ are radially R respositionable relative to the longitudinal axis x of the locking pin 10⁶ as between an outward expanded or locking position and an inward contracted or retraction position.

Insertion of the insert unit 12 into the bore 39⁶ of the housing unit 11 and movement of the activation member 70⁶ in the second longitudinal direction x₂ relative to the strut 50⁶ effects a longitudinal x separation of the proximal 60⁶p and distal 60⁶d ends of the leaf springs 60⁶ against the bias of the leaf springs 60⁶ so as to effect an inward movement of the catches 50⁶ towards the longitudinal axis x of the locking pin 10⁶.

As with the first and fifth embodiments, a pair of longitudinally x projecting finger tabs 80⁶ can be provided on the stop 40⁶ for facilitating retraction of the locking pin 10⁶. The finger tabs 80⁶ depicted in FIG. 8 are radially spaced from and diametrically positioned about the longitudinal axis x. The finger tabs 80⁶ project longitudinally x from the stop 40⁶ in a first longitudinal direction x₁ away from the catches 50⁶. The finger tabs 80⁶ are configured and arranged for engaging the tips of a pointer finger (not shown) and a middle finger (not shown). The finger tabs 80⁶ facilitate retraction of the locking pin 10⁶ by allowing a user to pull the finger tabs 80⁶ in the first longitudinal direction x₁ with a pointer (not shown) and middle (not shown) fingers while pushing the activation member 70⁶ with the thumb (not shown) on the same hand (not shown) in a second longitudinal direction x₂ opposite the first longitudinal direction x₁ to reposition the catch 50⁶ into the inward retraction position, thereby permitting the locking pin 10⁶ to be pulled out from the holes H₁ and H₃ in the connected elements E₁ and E₃ respectively.

What is claimed is:

1. A locking pin comprising:
a sleeve including a distal end, a proximal end, and a longitudinal bore having a longitudinal axis;
an activation member located in the longitudinal bore;
a base coupled to a distal end of the actuation member at a position opposite the distal end of the sleeve;
a spring applying a biasing force acting generally along the longitudinal axis to bias the base toward the distal end of the sleeve; and
a radially expandable catch located at an interface of the base and the distal end of the sleeve, the catch applying a radially inwardly biasing force at the interface, wherein the biasing force of the spring is greater than the biasing force of the catch to maintain the catch in an outward expanded position.

2. The locking pin of claim 1 wherein the catch in the outward expanded position comprises a diameter measured perpendicular to the longitudinal axis greater than a diameter of the sleeve.

3. The locking pin of claim 1 wherein displacement of the base away from the distal end of the sleeve permits the catch to move to an inward contracted position at the interface.

4. The locking pin of claim 1 wherein the catch in an inward contracted position comprises a diameter measured perpendicular to the longitudinal axis less than, or equal to, a diameter of the sleeve.

5. The locking pin of claim 1 wherein the catch is expanded to the outward expanded position by an inclined surface on at least one of the sleeve or the base.

6. The locking pin of claim 1 wherein the catch contracts to the inward contracted position by displacement of the base away from the distal end of the sleeve.

7. The locking pin of claim 1 comprising finger tabs located near the proximal end of the shaft.

8. The locking pin of claim 1 comprising a stop located near the proximate end of the shaft.

9. The locking pin of claim 1 wherein the base comprises a diameter measured perpendicular to the longitudinal axis that is less than, or equal to, a diameter of the sleeve.

10. The locking pin of claim 1 wherein the spring is located within the longitudinal bore.

11. The locking pin of claim 1 wherein the spring is interposed between the actuation member and the distal end of the sleeve.

12. The locking pin of claim 1 wherein the base comprises a bevel at the interface.

13. The locking pin of claim 1 wherein the distal end of the sleeve comprises a bevel at the interface.

14. The locking pin of claim 1 wherein the catch comprises an elastically deformable o-ring.

15. The locking pin of claim 1 wherein the catch, the spring, and activation member are formed as an interconnected assembly.

16. A locking pin comprising:
a sleeve including a distal end, a proximal end, and a longitudinal bore having a longitudinal axis;
an activation member located in the longitudinal bore;
a base coupled to a distal end of the actuation member at a positioned opposite the distal end of the sleeve at an interface;
a spring applying a biasing force acting generally along the longitudinal axis to bias the base toward the distal end of the sleeve;
a radially expandable catch located at the interface of the base and the distal end of the sleeve, the catch applying a radially inwardly biasing force on the interface, wherein the biasing force of the spring is greater than the biasing force of the catch to maintain the catch in an outward expanded position, and displacement of the base away from the distal end of the sleeve permits the catch to move to an inward contracted position at the interface; and
one or more inclined surfaces at the interface that facilitate movement of the catch from the inward contracted position toward the outward expanded position.

17. A method of operating a locking pin, the method comprising the steps of:
positioning an activation member in the longitudinal bore of a sleeve;
attaching a base to a distal end of the actuation member at a location opposite a distal end of the sleeve;
applying a longitudinal biasing force generally along the longitudinal bore to bias the base toward the distal end of the sleeve;
positioning a radially expandable catch at an interface of the base and the distal end of the sleeve, the longitudinal biasing force maintaining the catch in an outward expanded position; and
displacing the base away from the distal end of the sleeve to permit the catch to move to an inward contracted position at the interface.
